(19) United States
(12) Patent Application Publication
(10) Pub. No.: US 2007/0070169 A1
(43) Pub. Date: Mar. 29, 2007

(54) Laser positioning in an optical disc drive

(76) Inventor: D. Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/237,135

(22) Filed: Sep. 28, 2005

(51) Int. Cl. B41J 2/435

(52) U.S. Cl. 347/224

(57) ABSTRACT

Various apparatuses and methods for laser positioning in an optical disc drive are provided. In one embodiment, a laser positioning apparatus is provided in which an assembly is employed to position a first laser beam generated by a first laser relative to a first side of an optical disc site in the optical disc drive. Also, a structure is coupled to the assembly and configured to extend around an edge of the optical disc site to a second side of the optical disc site. The structure positions a second laser beam generated by a second laser relative to a second side of the optical disc site based upon a movement of the assembly.

### BACKGROUND

Recent advancements have made it possible to employ lasers in optical disc drives to perform the functions of reading data from and writing data to optical discs as well as writing labels or other information on a label surface of optical discs. In a typical scenario, to write data to a disc, the disc is placed in the disc drive and the write function is performed. Thereafter, the disc is removed from the drive, flipped over, and placed back into the drive to write a label to the label surface of the disc.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a first-view of relevant components in an optical disc drive employed to direct lasers at both sides of an optical disc according to an embodiment of the present invention;

FIG. 2 is a drawing of a second view of the components in the optical disc drive of FIG. 1 from an opposite direction according to an embodiment of the present invention;

FIG. 3 is a drawing of a side view of the components in the optical disc drive of FIGS. 1 and 2 according to an embodiment of the present invention;

FIG. 4 is a drawings of a first view of relevant components in an optical disc drive employed to direct lasers at both sides of an optical disc according to another embodiment of the present invention;

FIG. 5 is a drawing of a second view of the components in the optical disc drive of FIG. 4 from an opposite direction according to an embodiment of the present invention;

FIG. 6 is a drawing of a side view of the components in the optical disc drive of FIGS. 4 and 5 according to an embodiment of the present invention; and

FIG. 7 is a drawing of a side view of the components in an optical disc drive according to yet another embodiment of the present invention.

### DETAILED DESCRIPTION

The optical disc drives described herein include various components as depicted in the various figures that illustrate the various concepts according to various embodiments of the present invention. However, it is also understood that the optical disc drives may include other components not shown that are not particularly pertinent to the concepts described herein.

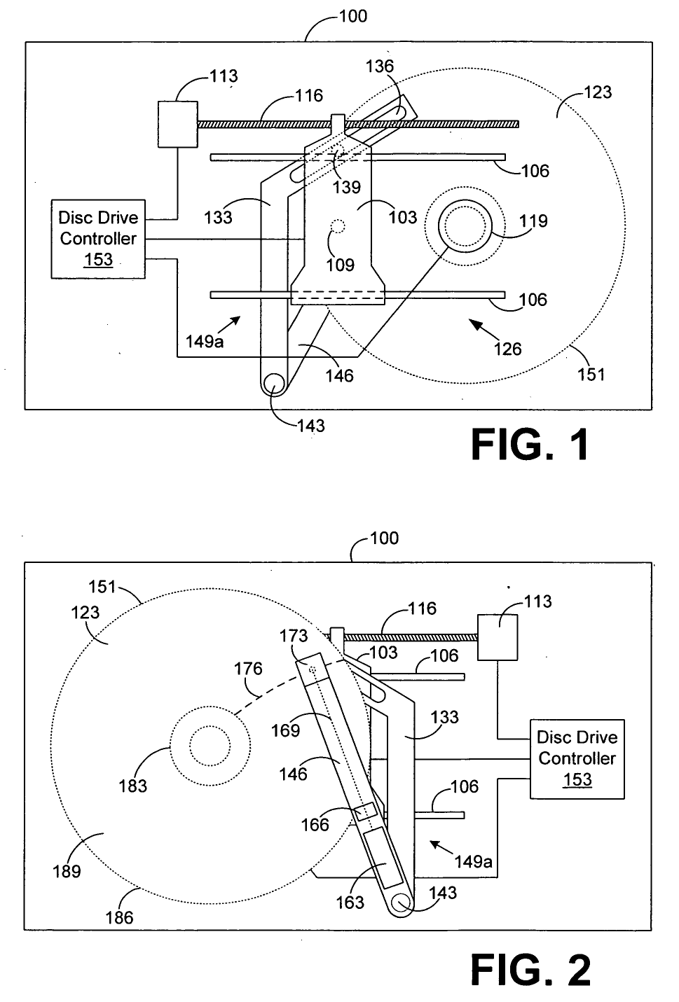

With reference to FIG. 1 shown is an optical disc drive 100 according to an embodiment of the present invention. The optical disc drive 100 includes an optical pick up unit 103 that slides along rails 106. Within the optical pick up unit 103 is a laser 109 which generates a laser beam as will be described herein. The optical disc drive 100 also includes a motor 113. The motor 113 may be, for example, a stepper motor or other type of motor as can be appreciated. The motor 113 is coupled to a screw shaft 116 that in turn is coupled to the optical pick up unit 103. The optical disc drive 100 further includes a spindle motor 119 that is employed to spin an optical disc placed in an optical disc site 123 of the optical disc drive 100. In this respect the optical disc site 123 comprises a three dimensional disc-like volume within which an optical disc may be placed. In this respect, the dimensions of the optical disc site 123 may approximate the dimensions of an optical disc. Also, in various embodiments, the dimensions of an optical disc may fit within the dimensions of the optical disc site 123.

The optical pick up unit 103, rails 106, the motor 113, and screw shaft 116 make up one example of a laser positioning assembly 126 that is employed to position the laser 109 so that a laser beam generated by the laser 109 may be directed toward a specific location on a first side of the optical disc site 123. Alternatively, assemblies other than a screw shaft/rail assembly may be employed to position the laser 109 as can be appreciated.

According to one example embodiment of the present invention, the optical disc drive 100 also includes an arm 133 that is operatively coupled to the optical pick up unit 103 by way of a slot 136 and a pin 139. The pin 139 protrudes from the optical pick up unit 103 and engages the slot 136. The arm 133 is also coupled to a pivot point 143. Also, the arm 133 is coupled to an additional arm 146 at the pivot point 143. The arms 133 and 146 are rigidly attached to each other at the pivot point 143 such that pivotal motion of the arm 133 about the pivot point 143 results in corresponding pivotal motion of the arm 146. Together, the arms 133 and 146, the pivot point 143, the slot 136 and pin 139 form structure 149a that is coupled to the laser positioning assembly 126 and is configured to extend around an edge 151 of the optical disc site 123 to the second side of the optical disc site 123. While the structure 149a is coupled to the assembly by virtue of the slot 136 and pin 139, it is understood that the structure may be coupled to the assembly in another manner as will be described.

The optical disc drive 100 also includes a disc drive controller 153 that generates appropriate electronic signals to drive the motor 113, the spindle motor 119, and the various components in the optical pick up unit 103. Such components may comprise, for example, the laser 109, and one or more sensors (not shown) as can be appreciated. In this respect, the described controller 153 orchestrates the operation of the optical disc drive 100 in both reading and writing data to a digital data region of one side of an optical disc disposed in the optical disc site 123, and in writing a label to a label region of the other side of an optical disc placed within the optical disc site 123.

Next, with reference to FIG. 2, shown as a second view of various components of the optical disc drive 100 according to various embodiments of the present invention. The view shown with reference to FIG. 2 is taken from an opposite direction as the view as depicted in FIG. 1 of the optical disc drive 100. In this respect, the entire arm 146 is shown. Disposed on the arm 146 is a laser 163 and beam shaping optics 166. A laser 163 generates a laser beam 169 that is shaped by beam shaping optics 166. The beam shaping optics 166 may comprise, for example, one or more lenses and other optical components as can be appreciated. Disposed at one end of the arm 146 is a reflector 173 that reflects the laser beam 169 generated by the laser 163 onto on to an optical disc placed in the optical disc site 123 as can be appreciated. The structure 149a ultimately positions the laser beam 169 relative to the respective side of the optical disc site based upon the movement or manipulation of the assembly 126. Also, the laser 163 may be mounted to the arm 146 in some other manner to direct the laser beam 169 toward an optical disc. For example, the laser 163 may be attached to the end of the arm 146 and pointed directly at the optical disc provided that the arm is designed to provide adequate stability.

Next, the operation of the optical disc drive 100 is described with reference to both FIGS. 1 and 2 according to the various embodiments of the present invention. To begin, the laser positioning assembly 126, positions a first laser beam (not shown) generated by the laser 109 relative to a first side of the optical disc site 123 in the optical disc drive 100. In this respect, given that, the optical pick up unit 123 is disposed on rails 106 as shown, the laser positioning assembly 126 is thus configured for linear positioning of the first laser beam generated by the laser 109 relative to the optical disc site 123 or relative to an optical disc disposed in the optical disc site 123. In this respect, a user may place an optical disc in the optical disc drive 100 such that the optical disc occupies the optical disc site 123.

According to one embodiment, the laser 109 is a “data side” laser, and the laser 163 is a “label side” laser. A data side laser is defined herein as a laser that is employed to read or write data digital or binary to an optical disc disposed in the optical disc site 123. A label side laser is defined herein as a laser employed to write an optically visible label to a label surface of an optical disc disposed in the optical disc site 123. According to the various embodiments of the present invention, the laser 109 may be either a data side laser or a label side laser. Similarly, the laser 163 may be a data side laser or a label side laser. With respect to the various embodiments described herein, to the extent that one of the lasers 109 or 163 is a data side, then the other one of the lasers 109 or 163 is label side laser as can be appreciated.

According to the various embodiments of the present invention, the laser positioning assembly 126 is employed to position the optical pick up unit 103, and therefore the laser 109 and the laser beam generated thereby, along a linear pathway relative to a first side of the optical disc site 123 in the optical disc drive. The arm 133 is operatively coupled to the optical pick up unit 103 by virtue of the slot 136 and the pin 139 described above. As the optical pick up unit 103 moves along the rails 106, the arm 133 pivots about the pivot point 143 as the pin 139 slides through the slot 136. In this respect, the arm 133 is a rotating arm that rotates about pivot point 143. Similarly, the arm 146 is also a rotating arm that rotates about the pivot point 143.

As the arm 133 rotates due to motion of the optical pick up unit 103, the arm 146 also rotates about the pivot point 143 in synchronicity with the arm 133 and positions the laser beam generated by the laser 163 relative to a second side of the optical disc site 123. In this respect, the arm 146 is coupled to the arm 133 through the pivot point 143 in a rigid manner as described above such that the pivot point 143 is common to both of the arms 133 and 146.

As the laser positioning assembly 126 positions the laser 109 relative to the side of the optical disc site 123 between end points of the possible motion of the laser 109, the arm 146 correspondingly positions the laser beam 169 generated by the laser 163 between an inner diameter 183 and an outer diameter 186 of a writing area 189 associated with the optical disc site 123. In this respect, the writing area 189 is the writing area of an optical disc within which digital/binary data or an optically visible laser may be written, where the optical disc is disposed in the optical disc site 123 as can be appreciated. Thus, the arm 146 is configured to position the laser beam 169 along a path extending from the inner diameter 183 to the outer diameter 186 of the optical disc site 123. According to one embodiment of the present invention, the path 176 traces an arc from the inner diameter 183 to the outer diameter 186 of the writing area 189 due to the pivoting of the arm 146. In one embodiment, the laser beam 169 is positioned along the path 176 in proportion to the movement of the laser 109. That is to say, the relative position of the laser beam 169 along the path 176 from the inner diameter 183 to the outer diameter 186 may be synchronized with the movement of the laser 109 between the inner diameter 183 to the outer diameter 186 as it faces the opposite side of an optical disc disposed in the optical disc site 123.

The motion of the arm 146 is generated the pin 139, which is inserted in the slot 136, sliding through the slot 136 during movement of the optical pick up unit 103 of the laser positioning assembly 126. In this respect, the optical pick up unit 103 may also be termed a “sled” that slides along at least one rail 106 as can be appreciated.

Because the arm 146 positions the laser beam 169 along the path 176 that traces the arc from the inner diameter 183 to the outer diameter 186, then the label writing or data reading/writing function of the laser 163 is adjusted to account for displacement of the laser beam 169 along the arc that is the path 176 along which the laser beam 169 is positioned, as opposed to a path that is a straight line such as is the case with the laser 109. That is to say, that each track of a data that is read from or written to, or each track of an optically visible label that is written to a surface of an optical disc disposed in the optical disc site 123 by the laser beam 169 is offset relative to the other tracks given that the laser beam 169 follows the path 176. In any event, the label writing function or data reading/writing function is adjusted so that the image lines of the tracks or the data stored therein lines up correctly to the extent necessary so as to result in the creation of a proper image or to ensure that the data is properly read from or written to an optical disc.

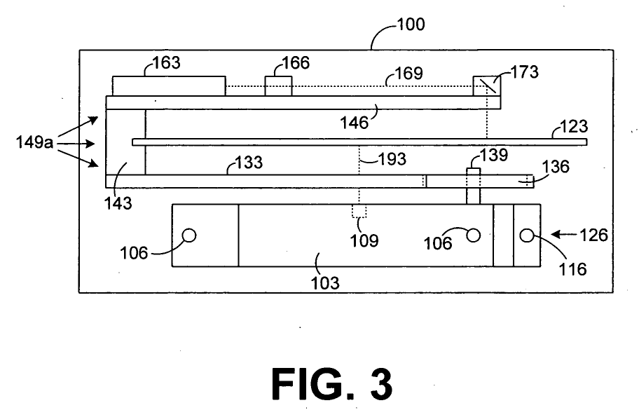

Next, with reference to FIG. 3 shown is a side view of the optical disc drive 100 that illustrates the pertinent components as described with reference to FIGS. 1 and 2 according to the various embodiments of the present invention. As shown, the optical disc drive 100 includes the optical pick up unit 103 that slides along the rails 106. Also, the laser 109 generates a laser beam 193 that is directed to the respective side of the optical disc site 123 (or a side of an optical disc disposed in the optical disc site 123). The motor 113 (FIG. 1) turns the screw shaft 116, thereby causing movement of the optical pick up unit 103.

The pin 139 protrudes from the optical disc unit 103 and extends through the slot 136 in the arm 133 as shown. In this respect, the structure 149a is “coupled” to the assembly 126 by way of the pin 139 and the slot 136. The arm 133 is coupled to the pivot point 143. Also, the arm 146 is coupled to the pivot point 143. Disposed on the arm 146 are the laser 163, the beam shaping optics 166, and the reflector 173 that reflects the laser beam 169 onto the optical disc site 123.

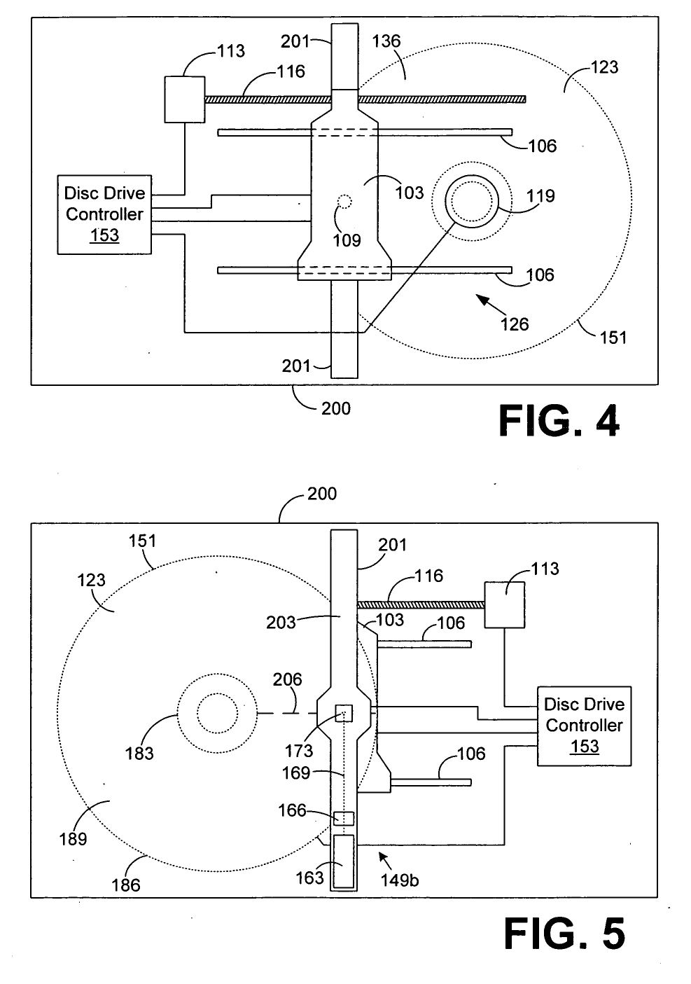

Turning now to FIG. 4, shown is an optical disc drive 200 according to another embodiment of the present invention. To the extent that the optical disc drive 200 includes components that are the same as those described in the optical disc drive 100 with reference to FIGS. 1-3, the same reference numbers are employed herein. For example, the optical disc drive 200 includes the laser positioning assembly 126 as described above. The optical disc drive 200 also includes structure 149(b) (FIG. 5) that is coupled to the assembly 126 and is configured to extend around the edge 151 of the optical disc site 123 to a second side of the optical disc site 123.

With reference to FIG. 5 shown is a second view of the optical disc drive 200 from an opposite point of view with respect to the view of the optical disc drive 200 shown in FIG. 4. The structure 149(b) comprises a bracket 201 that extends around the optical disc site 123. The bracket 201 includes a crossbeam 203. In one embodiment, the laser 163, beam shaping optics 166, and reflector 173 are attached to the crossbeam 203. In this respect the structure 149(b) comprising the bracket 201 positions the second laser beam 169 generated by the laser 163 relative to the respective side of the optical disc site 123 based upon movement of the assembly 126. In this respect, the structure 149(b) moves with the laser positioning assembly 126.

In one embodiment, the bracket 201 is coupled to the laser positioning assembly 126 in that the bracket 201 may be integrally molded to the optical pickup unit 103. Alternatively, the bracket 201 may be attached to the optical pick up unit 103 by virtue of appropriate fasteners such as screws, clips, or other fasteners. In addition, the bracket 201 may be coupled to the optical pick up unit 103 by way of a snap-on arrangement or other configuration as can be appreciated. The bracket 201 facilitates the positioning of the laser beam 169 along a path 206 that extends from the inner diameter 183 to the outer diameter 186 of a writing area associated with the optical disc site 123.

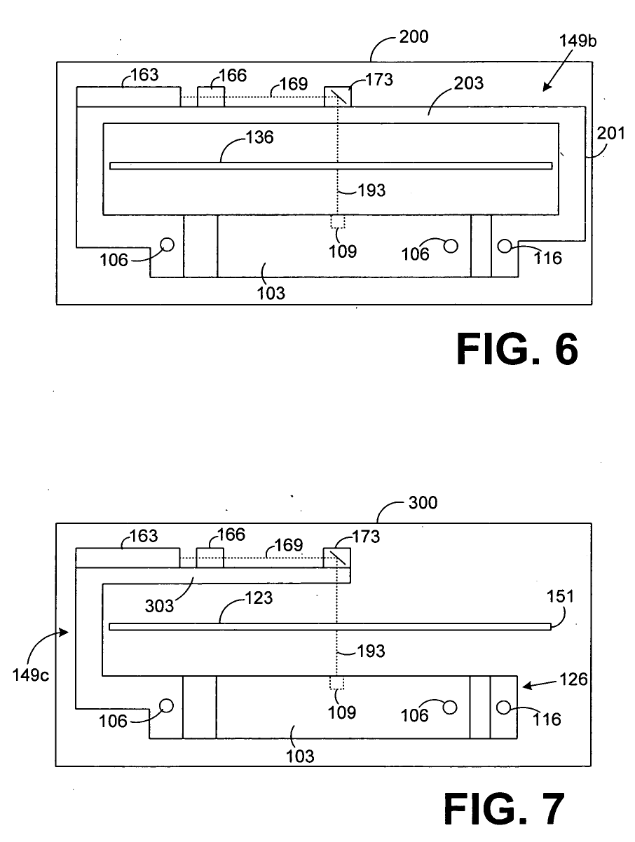

In this respect, the bracket 201 is configured to encircle the optical disc site 123 at a maximum width of the optical disc site 123 overlapped by the bracket 201, as best understood with reference to FIG. 6. The bracket 201 may be positioned so that the maximum overlapped width of an optical disc placed within the optical disc site 123 encircled by the bracket 201 does not come into contact with the bracket 201. In this respect, the bracket 201 may be configured to accommodate either the maximum width of the optical disc site 123 itself, or at least the maximum width of the portion of the optical disc site 123 that is ultimately encircled by the bracket 201 when the laser beam 169 is positioned at the inner diameter 183 of the optical disc site 123 as dictated by the path 206.

Referring next to FIG. 6, shown is a side view of the optical disc drive 200 according to an embodiment of the present invention. The bracket 201 includes the crossbeam 203 that spans the maximum width of the optical disc site 123 as described above. The second laser 163 is attached to the crossbeam 203. Also, the reflector 173 is attached to the crossbeam 203, where the reflector 173 directs the second laser beam 169 toward the side of the optical disc site 123.

Referring next to FIG. 7, shown is an optical disc drive 300 according to another embodiment of the present invention. The optical disc drive 300 includes components similar to those described above, where like numerals indicate like structures as described. In addition, the optical disc drive 300 includes an arm 303 that extends from the assembly 126 and around the edge 151 of the optical disc site 123. In this respect, the arm 303 comprises a structure 149(c) according to the present embodiment.

The laser 163, beam shaping optics 166, and the reflector 173 are attached to the arm 303. The reflector 173 directs the laser beam 169 toward the side of the optical disc site 123 as shown. The arm 303 is constructed of sufficient bulk so as to insure stability of the free end of the arm such that the laser beam 169 may be properly positioned with little or no vibration. That is to say, to the extent that vibration exists due to the configuration shown with reference to the arm 303, such vibration should not displace the laser beam 169 to an extent that such displacement adversely affects the operation of the optical disc drive 300.

According to various embodiments of the present invention, with reference to FIGS. 1 through 7, various methods are also provided. In one embodiment, a method is provided for laser positioning in an optical disc drive. This example method comprises the steps of generating a first laser beam with a data side laser; generating a second laser beam with a label side laser; manipulating an assembly to position the first laser beam relative to a first side of an optical disc in the optical disc drive; and positioning the second laser beam relative to a second side of the optical disc based upon the manipulation of the assembly. In addition, the present method further comprises performing the steps of generating the first laser beam, generating the second laser beam, manipulating the assembly to position the first laser beam, and positioning the second laser beam simultaneously.

In addition, in implementing various methods of the present invention, in another embodiment a user may first place an optical disc in the optical disc site 123 of the optical disc drive 100, 200, or 300 before performing the steps of generating the first laser beam, generating the second laser beam, manipulating the assembly to position the first laser beam, and positioning the second laser beam. Also, after performing the steps of generating the first laser beam, generating the second laser beam, moving the assembly to position the first laser beam, and positioning the second laser beam, a user may perform the step of removing the optical disc from the optical disc drive 100, 200, or 300.

Also, after the optical disc is placed in the optical disc site 123 of the optical disc drive 100, 200, or 300, the steps of both writing data to the first side of the optical disc using the first laser beam, and, writing a label to the second side of the optical disc with the second laser beam may be performed without removal of the optical disc from the optical disc drive 100, 200, or 300. In this respect, both the step of writing to and/or reading from the optical disc and the step of writing the label to the label side of the optical disc are performed without removal of the optical disc from the optical disc drive 100. This advantageously eliminates the necessity of a user having to remove the optical disc from an optical disc drive with a single laser in order to flip the optical disc over and place it back into the optical disc drive to be able to write a label to, or to write/read data to/from the opposite side the optical disc.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. An apparatus for laser positioning in an optical disc drive, comprising:
an assembly that positions a first laser beam generated by a first laser relative to a first side of an optical disc site in the optical disc drive;
a structure coupled to the assembly and configured to extend around an edge of the optical disc site to a second side of the optical disc site; and
a second laser configured to generate a second laser beam, the structure positioning the second laser beam relative to a second side of the optical disc site based upon a movement of the assembly.

2. The apparatus of claim 1, wherein the structure further comprises an arm extending from the assembly around the edge of the optical disc site.

3. The apparatus of claim 2, wherein the second laser is attached to the arm.

4. The apparatus of claim 2, further comprising a reflector attached to the arm, the reflector directing the second laser beam toward the second side of the optical disc site.

5. The apparatus of claim 1, wherein the structure positions the second laser beam along a path extending from an inner diameter to an outer diameter of a writing area associated with the optical disc site.

6. The apparatus of claim 1, wherein an optical disc occupies the optical disc site.

7. The apparatus of claim 1, wherein the first laser beam is generated by a data side laser and the second laser beam is generated by a label side laser.

8. The apparatus of claim 1, wherein the structure further comprises a bracket configured to encircle a maximum width of the optical disc site when the second laser beam is positioned at an inner diameter of a writing area of the optical disc site.

9. The apparatus of claim 8, wherein the bracket further comprises a crossbeam that spans the maximum width.

10. The apparatus of claim 9, wherein the second laser is attached to the crossbeam.

11. The apparatus of claim 9, further comprising a reflector attached to the crossbeam, the reflector directing the second laser beam toward the second side of the optical disc site.

12. The apparatus of claim 1, wherein the structure further comprises:
a first rotating arm operatively coupled to the assembly; and
a second rotating arm that positions the second laser beam relative to the second side of the optical disc site, the second rotating arm being coupled to the first rotating arm, and the first and second rotating arms rotating around a common pivot point.

13. The apparatus of claim 12, wherein the second rotating arm further comprises a slot, and the assembly includes a pin, wherein the pin is inserted in and slides along the slot during movement of the assembly.

14. An optical disc drive, comprising:
a first laser;
a second laser;
an assembly that positions a first laser beam generated by the first laser relative to a first side of an optical disc site in the optical disc drive;
a control system that controls the operation of the assembly;
a structure coupled to the assembly and configured to extend around an edge of the optical disc site to a second side of the optical disc site; and
a second laser configured to generate a second laser beam, the structure positioning the second laser beam relative to a second side of the optical disc site based upon a movement of the assembly.

15. The optical disc drive of claim 14, wherein the structure further comprises an arm extending from the assembly around the edge of the optical disc site.

16. The optical disc drive of claim 14, wherein the structure further comprises a bracket configured to encircle a maximum width of the optical disc site when the second laser beam is positioned at an inner diameter of a writing area of the optical disc site.

17. The optical disc drive of claim 14, wherein the structure further comprises:
a first rotating arm operatively coupled to the assembly; and
a second rotating arm that positions the second laser beam relative to the second side of the optical disc site, the second rotating arm being coupled to the first rotating arm, and the first and second rotating arms rotating around a common pivot point.

18. An optical disc drive, comprising:
means for generating a first laser beam;
means for generating a second laser beam;
means for positioning the first laser beam relative to a first side of an optical disc in the optical disc drive; and
means for positioning the second laser beam relative to a second side of the optical disc based upon the positioning of the first laser beam.

19. A method for laser positioning in an optical disc drive, comprising the steps of:
generating a first laser beam with a data side laser;
generating a second laser beam with a label side laser;
manipulating an assembly to position the first laser beam relative to a first side of an optical disc in the optical disc drive; and
positioning the second laser beam relative to a second side of the optical disc based upon the manipulation of the assembly.

20. The method of claim 19, wherein the steps of generating the first laser beam, generating the second laser beam, manipulating the assembly to position the first laser beam, and positioning the second laser beam are performed simultaneously.

21. The method of claim 19, further comprising the steps of:
placing an optical disc in the optical disc drive before performing the steps of generating the first laser beam, generating the second laser beam, manipulating the assembly to position the first laser beam, and positioning the second laser beam; and
removing the optical disc from the optical disc drive after performing all of the steps of generating the first laser beam, generating the second laser beam, moving the assembly to position the first laser beam, and positioning the second laser beam.

22. The method of claim 19, further comprising the steps of both writing data to the first side of the optical disc using the first laser beam, and, writing a label to the second side of the optical disc with the second laser beam without removal of the optical disc from the optical disc drive.
